(19) United States
(12) Patent Application Publication
(10) Pub. No.: US 2025/0002273 A1
(43) Pub. Date: Jan. 2, 2025

(54) PACKAGING MATERIAL CONVEYANCE SYSTEM HAVING AIR DUCTS

(71) Applicant: Pregis LLC, Bannockburn, IL (US)

(72) Inventors: Anthonius Johannes Maria Berkvens, Maastricht (NL); Maikel Henri Marie Janssen, Grevenbicht (NL); Jan Pieter Jozef Geurts, Hulsberg (NL)

(21) Appl. No.: 18/757,412

(22) Filed: Jun. 27, 2024

Related U.S. Application Data
(60) Provisional application No. 63/523,611, filed on Jun. 27, 2023.

(51) Int. Cl. B65G 51/04; B65B 35/28; B65G 51/24

(52) U.S. Cl. CPC B65G 51/04; B65B 35/28; B65G 51/24

(57) ABSTRACT

A packaging material conveyance system is configured to convey protective packaging articles including pads made of paper dunnage from a protective packaging machine to a receptacle. A main duct receives the articles output by the protective packaging machine and transports the articles to the receptacle. The articles are conveyed by an airflow generated by a blower that propels the articles through the main duct, and are deposited into the receptacle after being released through an outlet. The outlet may be associated with a diverter that forms part of the main duct in a closed position, and is configured to release the articles into the receptacle in an open position.

### CROSS-REFERENCE TO RELATED APPLICATION

The present application claims under 35 U.S.C. § 119 (e) the benefit of U.S. Provisional Application Ser. No. 63/523,611 filed on Jun. 27, 2023, the entire contents of which are incorporated by reference herein.

### BACKGROUND

### (a) Technical Field

The present disclosure is directed to a packaging material conveyance system, more particularly, to the packaging material conveyance system including at least one air duct for conveying packaging articles from a protective packaging machine to a receptacle.

### (b) Description of the Related Art

It is known to produce protective packaging articles including relatively lightweight plastic-based articles such as inflatable cushioning and air pillows, and move such articles from one place to another, e.g., using ducting. However, paper-based protective packaging articles have different considerations, and typically are heavier than the plastic-based articles. Such paper-based protective packaging articles, including dunnage, may be formed into paper packing cushions or pads. The paper-based articles may become jammed if conveyed using the same type of ducting as plastic-based articles.

Previous ducts used to convey paper-based articles rely on a blower producing an airflow on a single side. This type of air duct may be suitable for moving plastic-based articles, but presents problems for moving paper-based articles, which may have a relatively larger size and/or weight. With stiffer, larger dunnage, this can have the effect of forcing the dunnage against an opposite wall of the duct, resulting in the dunnage becoming stuck within the wall of the duct. It also can make it more likely that the dunnage becomes stuck at bends or joints of the duct. It would be desirable to provide a solution to allow paper-based articles to be conveyed through ducting without becoming stuck or jammed.

### SUMMARY

According to one aspect of the present disclosure, a packaging material conveyance system for conveying protective packaging articles from a protective packaging machine to a receptacle may include: a main duct having a packaging article inlet configured to receive formed packaging articles, and having a first outlet configured to allow the packaging articles to exit therefrom, the main duct being elongated and configured to transport the articles in a longitudinal direction within the main duct from the packaging article inlet to the first outlet; and a blower assembly operably connected to the main duct to generate airflow that enters the main duct from at least two non-adjacent sides of the main duct to propel the articles through the main duct.

The packaging article inlet may be connected to an outlet of the protective packaging machine that converts a high-density supply material into the packaging articles having a lower density than the supply material.

The receptacle may be arranged at the first outlet, and configured to receive the articles conveyed by an internal duct airflow from the packaging article inlet to the first outlet.

The conveyance system may further include a blower duct section fluidly connecting the blower assembly and the main duct to introduce the airflow at an angle relative to the longitudinal direction of the main duct.

The blower duct section may include first and second blower duct sections, and the airflow may include first and second air streams configured to enter the main duct via the first and second blower duct sections at first and second angles, respectively. For example, the first and second angles may be the same. The first and second angles may be not greater than about 90°, more preferably, the first and second angles may be not greater than about 60°.

According to the present disclosure, the first and second air streams may be configured to energize boundary layers on top and bottom sides of the articles, respectively, so as to accelerate the articles from the packaging article inlet of the main duct. For example, the first and second air streams may be configured to engage opposite sides of the articles.

According to the present disclosure, the blower may include a first blower for generating the first air stream and a second blower for generating the second air stream. For example, the first blower and the second blower may be arranged on the at least two non-adjacent sides of the main duct. The first and second blowers may be arranged proximate the packaging article inlet of the main duct.

According to the present disclosure, the main duct may include first and second duct sections, the first and second duct sections each defining a substantially straight path. The first and second duct sections may be rectangular in shape. For example, the first duct section may be generally horizontal and defines a change in elevation. An elbow of the main duct may be arranged between the first and second duct sections, the elbow being wider than the first and second duct sections. The main duct may be configured to receive the articles at the packaging article inlet that have been cut and separated by the protective packaging machine. For example, the articles may be paper dunnage pads, such as two-ply paper pads.

According to another aspect of the present disclosure, a packaging material conveyance system for conveying protective packaging articles from a protective packaging machine to a receptacle may include: a main duct extending a predetermined length from a packaging article inlet to at least a first outlet, the main duct configured to receive the articles output by the protective packaging machine and transport the articles to a first outlet corresponding to the receptacle, the main duct defining a longitudinal direction corresponding to a direction of travel of the articles in the main duct; a first blower operably connected to a first blower duct section for generating a first airflow that enters the main duct at a first predetermined angle relative to the longitudinal direction; and a second blower operably connected to a second blower duct section for generating a second airflow that enters the main duct at a second predetermined angle relative to the longitudinal direction, wherein the first and second air streams are configured to propel the articles through the main duct.

According to a further aspect of the present disclosure, a packaging material conveyance system for conveying protective packaging articles from a protective packaging machine to a receptacle may include: a main duct extending a predetermined length from a packaging article inlet to at least a diverter, the main duct configured to receive the articles output by the protective packaging machine and transport the articles to the diverter corresponding to the receptacle, the main duct defining a longitudinal direction corresponding to a direction of travel of the articles in the main duct; the diverter being configured to act as an outlet in an open position and as part of the main duct in a closed position, wherein in the open position the packaging articles are diverted into the receptacle and when in the closed position the packaging articles are configured to continue to an additional receptacle that follows the receptacle; a blower operably connected to the main duct, the blower oriented at an angle to the longitudinal direction of the main duct so as to generate airflow to propel the articles through the main duct; and the receptacle associated configured to receive the articles conveyed by the internal duct airflow from the inlet to the diverter.

According to the present disclosure, a portion of the diverter may be configured to rest within a notch when in the open position.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic view of a conveyance system including a protecting packaging machine, blowers, and a main duct in accordance with the present disclosure;

FIG. 2 is a partial schematic view of the protective packaging machine, the blowers, and the main duct of the conveyance system of FIG. 1;

FIG. 3 is a schematic cross-sectional view of a blower duct section arranged with respect to the main duct of the conveyance system of FIG. 1;

FIG. 4A is a schematic view of airflow through the blower duct section of FIG. 3 including an exemplary angle for measuring the airflow;

FIG. 4B is a schematic view of airflow through the blower duct section of FIG. 3 including an alternative exemplary angle for measuring the airflow;

FIG. 5 is a schematic cross-sectional view of an alternative blower duct section in accordance with the present disclosure;

FIG. 6A is a schematic view of a protective packaging article being conveyed in a main duct;

FIG. 6B is a schematic view of a main duct including exemplary streamlines representative airflow velocities through the main duct;

FIG. 7 is an isolated cross-sectional view of a diverter in a closed position included in the conveyance system of FIG. 1;

FIG. 8 is a cross-sectional view of the diverter of FIG. 8 in an open position; and

FIG. 9 is an isolated cross-sectional view of a section of an alternative main duct including a bend formed in the main duct in accordance with the present disclosure.

### DETAILED DESCRIPTION

The following discussion omits or only briefly describes conventional features of the disclosed technology that are apparent to those skilled in the art. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant disclosure, in combination with routine experiments, to achieve other outcomes not specifically disclosed in the examples or the embodiments.

Protective packaging articles are configured for placement within a packaging container or between items being shipped or stored, to protect the items, fill void space within the packaging container, and/or to prevent or inhibit the items from moving around within the container. The protective packaging articles include protective-fill articles that are typically provided individually or as a plurality of units that are configured to be placed into the void space to provide a desired level of packaging. Such units typically are of a predetermined size or can have predetermined dimensions and/or be selectively configurable in another dimension, such as length. In some examples, the size of the protective-fill articles can be configurable in a plurality or all of their dimensions. Protective-fill articles are typically resiliently compressible around corners, edges, and/or sides of a packaged item to fill the void space around the item, instead of assuming a solid shape that corresponds to the void space around the item. Protective-fill articles include, for example, void-fill articles and cushioning articles.

Void-fill articles typically provide minimal cushioning properties and are relatively soft. They are typically used to fill empty void space in packaging containers to reduce the movement within the container of lightweight items that are not delicate, such as a thin book. An example of void-fill includes crumpled-paper dunnage with a fairly weak loft pattern and other space fillers that are easily compressible.

Cushioning articles are configured to provide cushioning to the packaged items and protection to various degrees against shocks and impact. Examples of cushioning materials include inflatable air pillows and cushions, bubble wrap, paper dunnage with a loft structure capable of withstanding moderate shocks and impact, foam sheets, and packing peanuts. Typically, both void-fill and cushioning articles are provided as a plurality of units of one or more similar sizes, typically common predetermined sizes, although in some applications the void-fill or cushioning articles can be made to custom sizes. Some cushioning articles are also packaging containers, such as padded mailers or other containers with a padded wall.

Paper-based protective packaging, or dunnage, is produced by crumpling or otherwise deforming paper stock. More specifically, paper dunnage is produced by running a generally continuous strip of paper through a dunnage conversion machine. The continuous strip of paper can be provided from, for example, a roll of paper or a fanfold stack of paper. The dunnage conversion machine converts the paper stock material into a lower density paper dunnage material using, for example, opposing rollers between which the paper stock material is passed. The rollers grip and pull the paper stock material from the roll or stack, and deform the paper stock material as the material passes between the rollers. The resulting paper dunnage can be cut into desired lengths to form individual pieces (or paper cushions or pillows) that can be provided to effectively fill a void space within a container holding a product.

A protective packaging machine conveyance system is also referred to herein as a conveyance system. As discussed above, conveyance systems are used to transport packaging articles (e.g., pieces of paper dunnage) from a protective packaging machine to one or more receptacles. Current conveyance systems typically are designed to convey lightweight packaging articles such as inflated air cushions or similar packaging material from a source of packaging articles (e.g., an inflation and sealing device, dunnage conversion machine or similar device) to a location where the packaging articles can be used. However, current conveyance systems struggle to convey heavier packaging articles such as paper pads, mailers or similar packaging articles. The heavier packaging articles have been found to cause jams and other similar issues within the conveyance systems. The present disclosure relates to improvements in conveyance systems.

A conveyance system used in conjunction with a protective packaging machine for conveying paper dunnage utilizes air ducts to transport pieces of the paper dunnage (i.e., paper cushions or pillows) from the outlet of the protective packaging machine (e.g., a dunnage conversion machine) to individual receptacles. The receptacle may be an overhead hopper associated with a workstation, and the pieces of paper dunnage may be conveyed by one or more air blowers and ducting to the overhead hopper at the workstation.

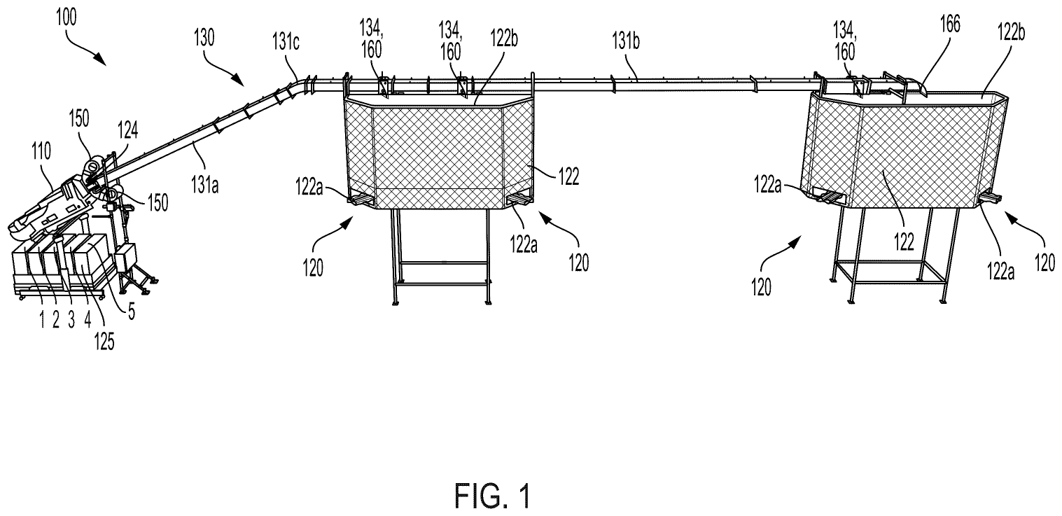

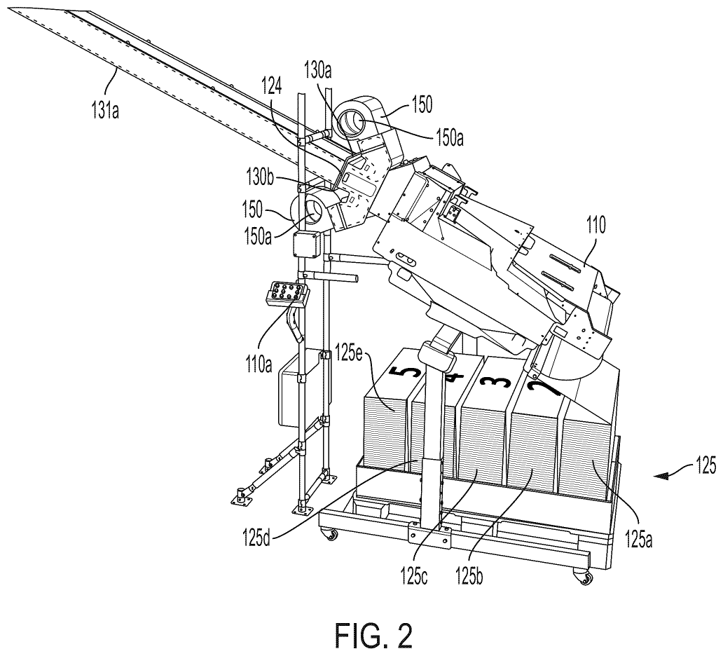

Referring to FIGS. 1 and 2, a conveyance system 100 is shown. The conveyance system 100 transports packaging articles created at a protective packaging machine 110 (e.g., a dunnage conversion machine) to one or more receptacles 122 such as overhead hoppers or other holding containers, vessels, or repositories. Alternatively, instead of the receptacles (e.g., overhead hoppers) 122, the receptacles 122 can be replaced by a conveyor belt such as a snake conveyor.

Preferably each of the receptacles 122 is associated with one or more workstations 120 where the packaging articles can be retrieved by an operator for packaging and shipping purposes. For example, the packaging articles may be used to surround a fragile item in a box being shipped or a similar use. The packaging articles created by the protective packaging machine 110 preferably are paper cushions or pillows (i.e., paper dunnage), but the conveyance system 100 may be used to transport other articles including cushioning materials such as inflatable air pillows and cushions.

When the protective packaging machine 110 is a dunnage conversion machine, it is configured to create paper-based protective packaging dunnage from stock material such as stock paper. The stock material is converted from a first high-density configuration to a second low density configuration. The stock material may be a fanfold stack of paper 125 in a high-density configuration. Alternatively, the stock material can be a roll of paper with a high-density configuration. Optionally, the stock material is a recyclable or carbon neutral material.

As shown in FIG. 2, the fanfold stack of paper 125 includes a plurality of stacks 125a, 125b, 125c, 125d and 125e, where each stack may include a single or a plurality of blocks (e.g., four blocks). Typically, the last sheet of a block is spliced to a first sheet of a next block, such that the blocks are daisy-chained together. Examples of the fanfold stack of paper 125 include stock material with 30-inch transverse widths and/or 15-inch transverse widths. Preferably these sheets are fan-folded as single layers. Alternatively, multiple layers of sheets can be fan-folded together such that dunnage is made of superimposed sheets that are crumpled together in the conversion process. Any suitable stock material may be used. For example, the stock material can have a basis weight of about 20 lbs. to about 100 lbs. The stock material may comprise paper stock stored in a high-density configuration having a first longitudinal end and a second longitudinal end, that is later converted into a low-density configuration by the protective packaging machine 110. The stock material can be a ribbon of sheet material that is stored in a fan-fold structure as shown in FIG. 2.

The supply units of stock material may have fan-fold configurations. For example, a foldable material, such as paper, may be folded repeatedly to form a stack or a three-dimensional body. The term “three-dimensional body,” in contrast to the “two-dimensional” material, has three dimensions all of which are non-negligible. A continuous sheet, e.g., a sheet of paper, plastic, or foil, can be folded at multiple fold lines that extend transversely to a longitudinal direction of the continuous sheet, or transversely to the feed direction of the sheet. For example, folding a continuous sheet that has a substantially uniform width along transverse fold lines can form or define sheet sections that have approximately the same width. The continuous sheet can be folded sequentially, in opposite or alternating directions, to produce an accordion-shaped continuous sheet. For example, the folds may form or define sections along the continuous sheet, and the sections may be substantially rectangular.

For example, sequentially folding the continuous sheet may produce an accordion-shaped continuous sheet with sheet sections that have approximately the same size and/or shape as one another. Multiple adjacent sections that are defined by the fold lines can be generally rectangular, and can have the same first dimension, e.g., a dimension corresponding to the width of the continuous sheet, and the same second dimension that is generally along longitudinal direction of the continuous sheet. For example, when the adjacent sections are contacting one another, the continuous sheet may be configured as a three-dimensional body or a stack, in an accordion shape that is formed by the folds and be compressed, so that the continuous sheet forms a three-dimensional body or stack.

The fold lines of the stock material can have any suitable orientation relative to one another, as well as relative to the longitudinal and transverse directions of the continuous sheet. Also, the stock material unit can have transverse folds that are parallel one to another. For example, the sections that are formed by the fold lines can be compressed to form a three-dimensional body that is a rectangular prismoid. Also, the stock material can have one or more folds that are non-parallel relative to the transverse folds.

The stock material can be provided as any suitable number of discrete stock material units. For example, two or more stock material units can be connected together to provide a continuous feed of material into the dunnage conversion machine. The material can be fed from the connected stock material units sequentially or concurrently, i.e., in series or in parallel. The stock material units can have various suitable sizes and configurations, and may include one or more stacks or rolls of suitable sheet materials. The term “sheet material” refers to a material that is generally sheet-like and two-dimensional, i.e., two dimensions of the material are substantially greater than the third dimension so that the third dimension is negligible or de minimus in comparison to the other two dimensions. Also, the sheet material can be generally flexible and foldable, such as the illustrative materials described herein.

The stock material units can include an attachment mechanism that connects multiple units of stock material, for example, to produce a continuous material feed from multiple discrete stock material units. The respective end and beginning of consecutive rolls can be joined by adhesive or other suitable means, to facilitate daisy-chaining the rolls together to form a continuous stream of sheet material that can be fed into the protective packaging machine, e.g., a dunnage conversion machine. Examples of suitable dunnage conversion machines include those disclosed in U.S. Patent Application Publication No. US 2019/0193364 published on Jun. 27, 2019; U.S. Pat. No. 11,235,548 issued Feb. 1, 2022; and U.S. Ser. No. 18/340,805 filed on Jun. 23, 2023.

Folding a continuous sheet along the transverse fold lines can form or define generally rectangular sheet sections. The rectangular sheet sections can stack together by, for example, folding the continuous sheet in alternating directions, to form the three-dimensional body that has longitudinal, transverse, and vertical dimensions. The stock material from the stock material units can be fed through an intake to the protective packaging machine shown in FIGS. 1 and 2. In some applications, the transverse direction of the continuous sheet of stock material can be greater than one or more dimensions of the intake. For example, the transverse dimension of the continuous sheet can be greater than the diameter of a generally round intake. Reducing the width of the continuous sheet in this manner at the start of the conversion process can facilitate passage thereof into the intake. The decreased width of the leading portion of the continuous sheet may facilitate smoother entry and/or transition of a daisy-chained continuous sheet and/or may reduce or eliminate catching or tearing of the continuous sheet. Moreover, reducing the width of the continuous sheet at the start thereof can facilitate connecting together or daisy-chaining two or more stock material units. For example, connecting or daisy-chaining material with a tapered section may be accomplished using smaller connectors or splice elements than would be required otherwise. Also, tapered sections may be easier to manually align and/or connect together in comparison to full-width sheet sections.

Referring to FIGS. 1 and 2, the protective packaging machine 110 preferably converts one or multiple plies of paper-based stock material into a pad. For example, the multiple plies are held together by a zipper formed by the protective packaging machine 110. The protective packaging machine 110 may include a separating/cutting device having a blade, and be configured to separate or cut the packaging articles prior to the packaging articles entering the main duct 130. The main duct 130 preferably is arranged at an outlet of the protective packaging machine 110 downstream of the blade of the separating/cutting device. In some examples, the pad is a predetermined length and thickness. For example, the pad may have a minimum height of about 2 cm or 4 cm and a maximum height of about 6 cm or 8 cm. The pad may have a minimum length of about 1 cm or 3 cm and a maximum length of about 80 cm or 100 cm. The height and length of the pad may be set in advance, or during operation of the protective packaging machine 110 to any range within the above minimums and maximums.

Alternatively, the protective packaging machine 110 may be replaced by an accumulator or dispenser of premade protective packaging articles, e.g., dunnage. As a further alternative, the protective packaging machine 110 may be replaced by a device that does not create dunnage and instead simply conveys packaging articles, such as the packaging materials discussed above, to the main duct 130 of the conveyance system 100. For example, instead of producing paper dunnage, the protective packaging machine 110 may be an inflatable cushion inflation and sealing device, the protective packaging machine 110 can create void fill articles or cushioning materials, or the protective packaging machine 110 can create envelopes, or any other suitable dunnage, packing peanuts, foam sheets, mailers, padded mailers or mailing or dunnage material or any other cushioning article, void fill article or paper-based packaging materials.

Referring again to FIGS. 1 and 2, the conveyance system 100 includes a main duct 130 operably connected to the protective packaging machine 110. The main duct 130 has at least one blower 150 operably connected to the main duct 130 to transport packaging articles from the protective packaging machine 110 to the receptacles 122 via airflow (e.g., an air stream) from the at least one blower 150. As shown in FIG. 1, the main duct 130 includes a packaging article inlet 124 that is connected to the outlet of the protective packaging machine 110. The main duct 130 further includes one or more outlets 134 that correspond to one or more receptacles 122. The receptacles 122 are configured to receive packaging articles from the protective packaging machine 110 through the main duct 130. The packaging article inlet 124 connects the main duct 130 to the protective packaging machine 110 to receive the dunnage from the protective packaging machine 110, preferably just downstream of the separating/cutting device. Packaging articles may be transported from the outlet of the protective packaging machine 110 through the main duct 130 to the receptacles 122, as a result of airflow generated by the blowers 150.

The packaging article inlet 124 may be arranged at a distance less than an anticipated length of the dunnage from the outlet of the protective packaging machine 110. For example, the distance between the outlet of the protective packaging machine 110 and the packaging article inlet 124 may be less than about 100 cm, which is the anticipated maximum length of the dunnage. The airflow within the main duct 130 will tend to propel the articles through the main duct 130, at least because in the present disclosure, the airflow enters the main duct 130 from at least two non-adjacent sides of the main duct 130, which will energize a boundary layer adjacent to first and second side walls 130a, 130b of the main duct 130, as described herein.

Referring to FIG. 1, the main duct 130 extends in a longitudinal direction that corresponds to a direction which packaging articles travel through the main duct 130. The main duct 130 may include a single section or a plurality of interconnected sections. As shown, the main duct 130 extends from the packaging article inlet 124 to at least an outlet (e.g., a first outlet) 134 that corresponds to one of the receptacles 122. At least one of the blowers 150 is operably connected to the main duct 130 to generate airflow (e.g., an air stream) that enters the main duct 130 from at least two non-adjacent sides of the main duct 130 to propel the packaging articles through the main duct 130.

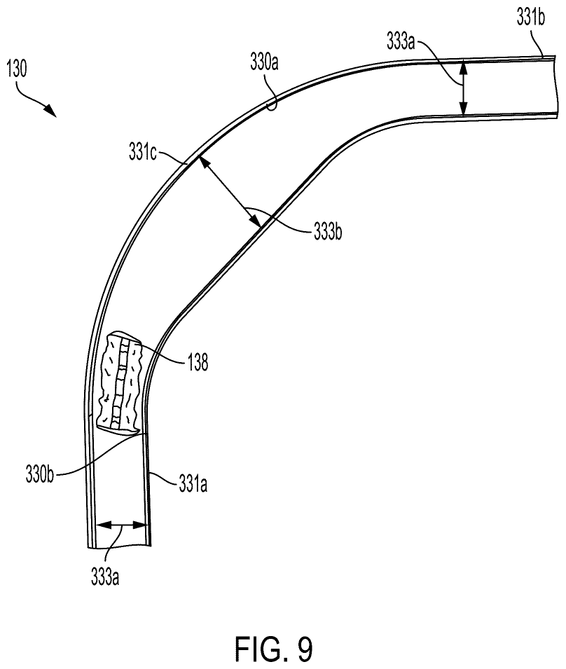

The main duct 130 includes a first duct section 131a that extends at an upward angle from the protective packaging machine 110 and defines a change in elevation. The first duct section 131a is connected to a second duct section 131b that extends from the first duct section 131a in approximately a horizontal direction. The second duct section 131b is configured to extend over the receptacles 122 to distribute the packaging articles from the protective packaging machine 110 to the receptacles 122. The main duct 130 additionally may include an elbow 131c between the first duct section 131a and the second duct section 131b. As described with reference to FIG. 9, the elbow 131c has a greater height than other portions of the main duct 130 to prevent dunnage from being stuck against one or more walls of the main duct 130 as the duct transitions from the first duct section 131a to the second duct section 131b.

Optionally, the main duct 130 may additionally include a propelling device configured to assist in propelling packaging articles through the main duct 130. For example, the propelling device may be a conveyor belt, a paddle wheel, a brush-type wheel mechanism or any other suitable device arranged within or adjacent to the main duct 130 to propel the packaging articles through the main duct 130. Any such propelling device optionally may be included to generate an additional air stream to be added to the airflow in the main duct 130 at some point downstream of the blower(s) 150. However, in the embodiment described herein, such a propelling device is not necessary to generate sufficient airflow to propel the articles through the main duct. Instead, according to the present disclosure, a suitable airflow is generated as the result of generating airflow in the main duct 130 by energizing the boundary layer in the main duct 130, which is achieved by directing air streams from blower(s) 150 via two non-adjacent sides of the main duct 130.

According to the present disclosure, the blower 150 (or multiple blowers 150) is/are provided to generate the respective air streams through a blower duct section 132 (or a plurality of blower duct sections 132), where the air stream(s) produce airflow that is configured to enter the main duct 130 to propel articles through the main duct 130. In the embodiment depicted in FIGS. 1-4, two blowers 150 are used in conjunction with the conveyance system 100. However, any number of blowers 150 may be used, including a single blower or three or more blowers.

In the embodiment shown in FIGS. 1-5, the main duct 130 includes first and second blowers 150 with corresponding blower duct sections 132 extending from the respective blowers 150. Alternatively, it is possible to replace the first and second blowers 150 with a single blower in which an airflow is conveyed to at least two sides of the main duct 130, e.g., circumferentially around the main duct 130, or in which a plurality of air streams are branched from the single blower through respective blower duct sections 132 and conveyed to at least two sides of the main duct 130.

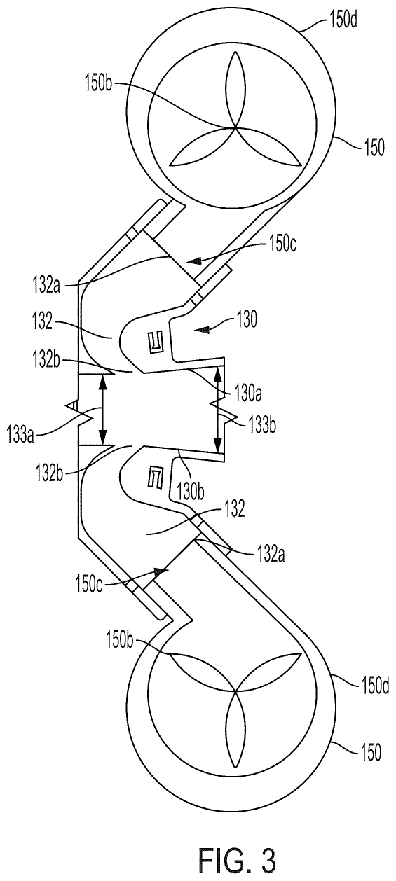

Referring to FIG. 3, the main duct 130 includes first and second blowers 150 arranged on non-adjacent sides of the main duct 130, respectively, corresponding to the first and second side walls 130a, 130b. The first and second side walls 130a, 130b of the main duct 130 generally extend in the longitudinal direction. In particular, the first and second side walls 130a, 130b of the main duct 130 may be arranged generally opposite to each other. As shown in FIG. 3, the main duct 130 may be rectangular in shape, and the first and second side walls 130a, 130b may be arranged on opposite sides of the main duct 130. Alternatively, the main duct 130 can be any other suitable shape, including but not limited to round, circular, oval, curved, trapezoidal, etc. The blowers 150 can be any suitable air moving device. The blowers 150 include an inlet 150a (see FIG. 2) and blades 150b (see FIG. 3) which pull air into the blower 150 through the inlet 150a and push air out of the blower 150 through an outlet 150c (see FIG. 3). The blower 150 includes an outer housing 150d which houses the blades 150b. The outer housing 150d preferably has a volute shape, but may be any other suitable shape such as rectangular, circular, etc.

The blowers 150 optionally may have multiple settings which can be changed depending, e.g., on the type, size, and density of the packaging article that is entering the main duct 130 from the protective packaging machine 110. For example, the blowers 150 may utilize a higher power setting (e.g., a higher speed of airflow) for high density dunnage or packaging articles such as paper pads and a lower power setting (e.g., lower speed of airflow) for a lower density packaging article such as an inflatable cushion. The setting of the blowers 150 may be changed by the user at the control panel 110a of the protective packaging machine 110. Optionally, the conveyance system 100 may include systems which automatically detect and determine the dunnage and power setting for the blowers.

The blowers 150 are arranged to provide air streams on at least two non-adjacent sides (e.g., opposite sides) of the main duct 130 so as to produce an internal duct airflow to propel the packaging articles through the main duct 130. The outlets 150c of the blowers 150 are connected to the main duct 130 by the respective blower duct sections 132. Each of the blower duct sections 132 has an opening 132a which receives the outlet 150c of the blower 150 and decreases in size as the blower duct section 132 approaches a duct communication section 132b which is connected to the main duct 130, thereby increasing the velocity of the airflow at the duct communication system 132b as compared to the airflow at the outlet 150c of the blower 150.

As provided herein, the blower duct sections 132 communicate with the main duct 130 at similar angles. However, the blower duct sections 132 may communicate with the main duct 130 at different angles. The air streams generated by the blowers 150 are transmitted through the blower duct sections 132 and generate airflow through the main duct 130 to propel the packaging articles from the protective packaging machine 110 through the main duct 130.

The blower duct sections 132 are connected to the main duct 130 at the first and second side walls 130a, 130b of the main duct 130 such that the air from the blowers 150 contacts as much of the dunnage or packaging articles from the protective packaging machine 110 as possible. For example, if the protective packaging machine is being used to create pads of paper dunnage, the blowers 150 will be configured to contact as much surface area of the pads of dunnage as possible. As shown, the blowers 150 are positioned at the first and second side walls 130a, 130b of the main duct 130 such that the packaging articles from the protective packaging machine 110 may pass through approximately a center of the main duct 130 to prevent potential jams. Alternatively, a single blower could be attached to the main duct 130 at first and second sides of the duct via the blower duct sections 132. Preferably the blowers 150 are arranged proximate the packaging article inlet 124. Alternatively, the blowers 150 may be arranged downstream of the packaging article inlet 124. Further, it is possible to position additional blowers 150 at other locations along the main duct 130 to provide more force from the air of the blowers 150 to keep the packaging articles moving through the main duct 130.

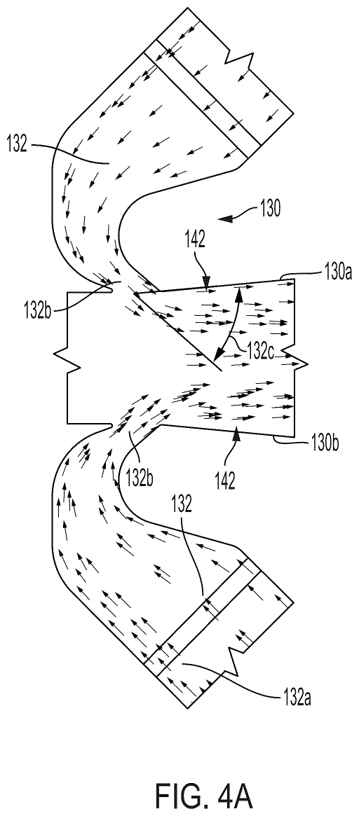

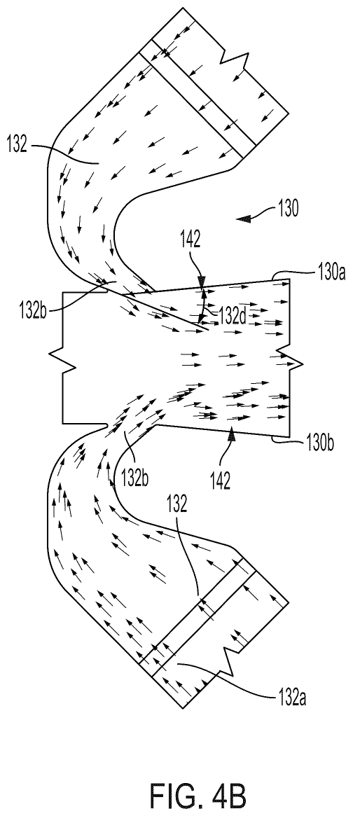

Referring to FIGS. 4A-4B, the duct communication section 132b is configured to direct the air streams from the blowers 150 at an angle 132c relative to one of the side walls 130a or 130b of the main duct 130. As shown in FIG. 4A, the angle 132c is exemplary of an air stream entering the main duct 130 via approximately a center of the duct communication section 132b, and is measured relative to a closest side wall 130a or 130b of the main duct 130. Alternatively, the angle 132c can be measured as an angle between a longitudinal direction through a center of the blower duct section 132 and the longitudinal direction through the center of the main duct 130. The angle 132c should not exceed about 90°, or more preferably, should not exceed about 60°. Therefore, any range of angles from about 0° to about 60° should provide suitable airflow to propel the articles. The angle 132c should be sufficient such that the airflow propels the articles through the main duct 130 without causing the articles to be caught or stuck in the first or second side walls 130a, 130b of the main duct 130, or within the duct communication section 132b. As shown in FIG. 4B, an angle 132d may be measured between a side of the blower duct section 132 at the duct communication section 132b and one of the side walls 130a or 130b of the main duct 130. The angles 132c and 132d in FIGS. 4A and 4B, respectively, are merely exemplary, and the angle of the airflow entering the main duct 130 from the blower duct sections 132 can be measured in any other suitable manner.

According to the present disclosure, by directing the airflow from the blower duct section 132 through the duct communication section 132b and into the main duct 130, it is possible to propel articles through the main duct 130. This is achieved, in part, by energizing the boundary layer 142. In particular, a boundary layer is a thin layer of fluid (e.g., air) in the immediate vicinity of a boundary surface, i.e., formed adjacent to the side walls 130a, 130b of the main duct 130 by the fluid flowing along the surface. By introducing the airflow from the blower duct section 132 into the main duct 130, it is possible to energize the airflow by adding momentum to the boundary layer, which enables the boundary layer 142 to stay on the surface of the side walls 130a, 130b for a longer distance in the main duct 130.

The boundary layer 142 is energized or enhanced by directing air streams into the main duct 130 from at least two non-adjacent sides of the main duct 130. As compared to conventional air ducts, in which a single stream of air is directed into the duct, the present disclosure enables the airflow to move with sufficient velocity to propel the articles through the main duct 130.

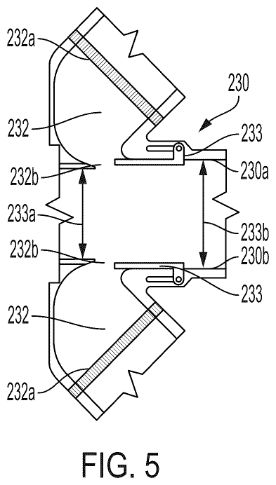

FIG. 5 shows a portion of an alternative main duct 230 according to the present disclosure. A blower duct section 232 is provided that is similar to the blower duct section 132 depicted in FIGS. 3-4. However, the blower duct section 232 in FIG. 5 includes a door 233. The door 233 can selectively block the blower duct section 232 to prevent airflow from the blowers from reaching the main duct 230, or it can be closed partially to change the size of an opening at a blower duct communication section 232b to partially restrict, accelerate, or aim the flow into the main duct 230. For example, the door 233 may include a peg that slides longitudinally within a groove formed as part of the main duct 230. Operation of the door 233 can be controlled at the control panel 110a. Alternatively, the door can be moved on a hinge or other mechanisms. As a further alternative, rather than using a door, the blower(s) can be turned on or off to control airflow.

The main duct 230 is similar to the main duct 130 depicted in FIGS. 3-4. The portion of the main duct 230 includes blower duct sections 232 which may be operably connected to one or more blowers in the same manner as the main duct 130 of FIGS. 3-4. The blower duct sections 232 include openings 232a, which correspond to the openings 132a (of FIGS. 3-4) and duct communication sections 232b which correspond to the duct communication systems 132b (of FIGS. 3-4). The duct 232 has first and second sides 230a, 230b with one of the blower duct sections 232 arranged at either side. The main duct 230 has a first width 233a between the first and second sides 230a, 230b prior to where the blower duct sections 232 intersect the main duct 230. Downstream of the blower duct sections 232, the main duct 230 has a second width 233b between the first and second walls 230a, 230b. The width of the main duct 230 in this embodiment increases in a step between the first width 233a and the second width 233b. The main duct 230 then may form a substantially constant width for the remaining portion of the main duct 230. The blower(s) can be operably connected to the blower duct sections 232, and to stop airflow, the blower(s) can be turned off.

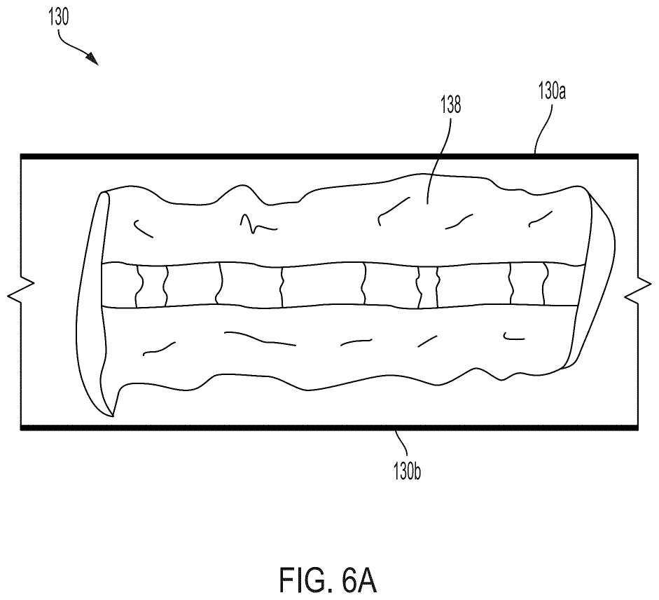

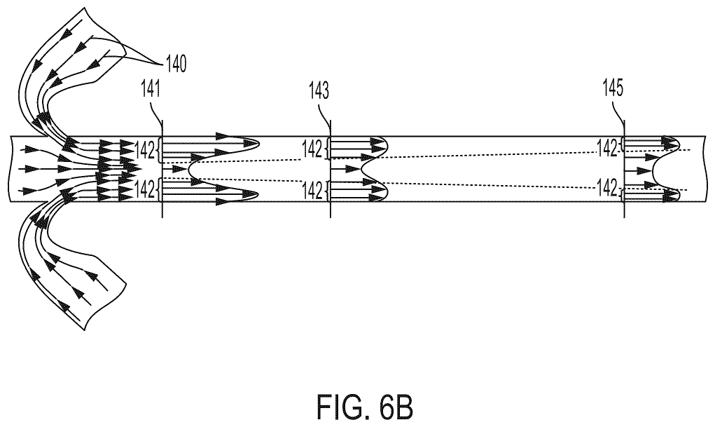

Referring to FIG. 6A, a piece of dunnage 140 is depicted inside a section of the main duct 130. The piece of dunnage 140 is depicted as an article (e.g., a pad). Air pushes the dunnage 140 downstream through the main duct 130, and as the dunnage 140 moves inside the main duct 130, the energized boundary layer helps prevent the dunnage 140 from settling or getting pushed against a wall enough to get stuck, such as due to friction, or at a joint between components of the main duct 130.

Referring to FIG. 6B, the airflow within the main duct 130 exhibits a boundary layer 142 adjacent each of the side walls 130a, 130b, and the airflow has a velocity that is higher on outer portions (e.g., near the side walls 130a, 130b) as compared to a central portion between the side walls 130a, 130b. In addition, the internal airflow velocity and pressure can vary along various cross-sections of blower duct sections 132 and the main duct 130. For example, the velocity of airflow within the blower duct sections 132, especially in the duct communication section 132b can be higher than the velocity of airflow within the central portion of the main duct 130. The difference in airflow velocity and pressure assists in forming the boundary layer 142. In FIG. 6B, exemplary streamlines represent airflow velocities through the main duct 130. In particular, streamlines 140 depict airflow velocities through the blower duct sections 130. As shown, the streamlines 140 being a wider distance apart represent slower velocities, whereas when the streamlines 140 are closer together, the velocities are faster. The airflow velocity as represented by the streamlines generally speeds up after the blower(s), and reaches a maximum in a neck area that corresponds to the duct communication sections 132b. In the main duct 130, the airflow velocity is faster in the boundary layer 142. In particular, representative airflow velocities in the main duct 130 are shown at three exemplary cross sections 141, 143, and 145. As shown, airflow velocities are relatively higher in the boundary layer 142 located at outer portions of the main duct 130 as compared to the central portion of the main duct 130. This results from the boundary layer 142 being energized as a result of air streams being directed into the main duct 130 from at least two non-adjacent sides of the main duct 130. Although every fluid flow adjacent a surface will exhibit a boundary layer, according to the present disclosure, the boundary layer is energized (i.e., the airflow velocity is accelerated) by generating the air streams from the different, non-adjacent sides of the main duct 130, as compared to an arrangement in which only a single air stream is directed into a duct.

The velocity within the blower duct sections 132 according to the present disclosure can be approximately 5 to 20 m/s. The velocity in the duct communication sections 132b can be approximately 20 to 30 m/s. The velocity within the central portion of the main duct 130 may be approximately 8 to 10 m/s. The pressure within the outer portions of the main duct 130 near the side walls 130a, 130b may be between 15 and 20 m/s.

The pressure within the blower duct sections 132 and the main duct 130 can be at or near atmospheric pressure of 101,325 Pa. For example, the pressure in the blower duct sections 132 may exceed atmospheric pressure by approximately 400 to 500 Pa. The pressure in the duct communication sections 132b can be within approximately 100 Pa of atmospheric pressure. The pressure within the central portion of the main duct 130 also can be between within approximately 100 Pa of atmospheric pressure. The pressure in the outer portions of the main duct 130 near the side walls 130a, 130b further can be between within approximately 100 Pa of atmospheric pressure

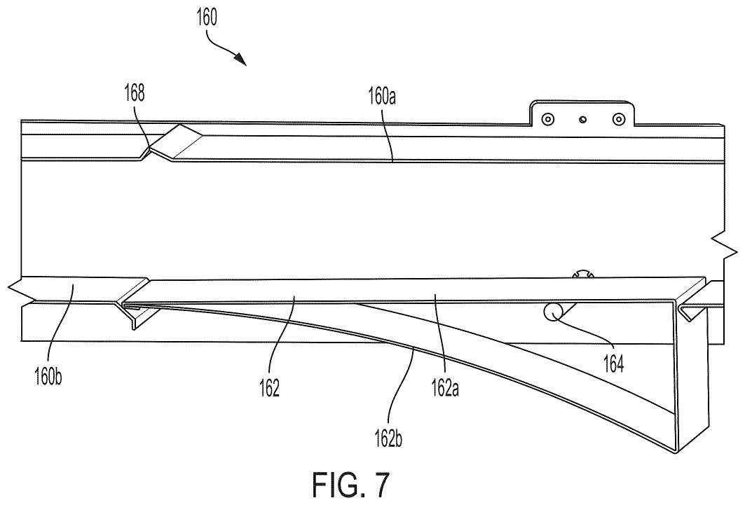

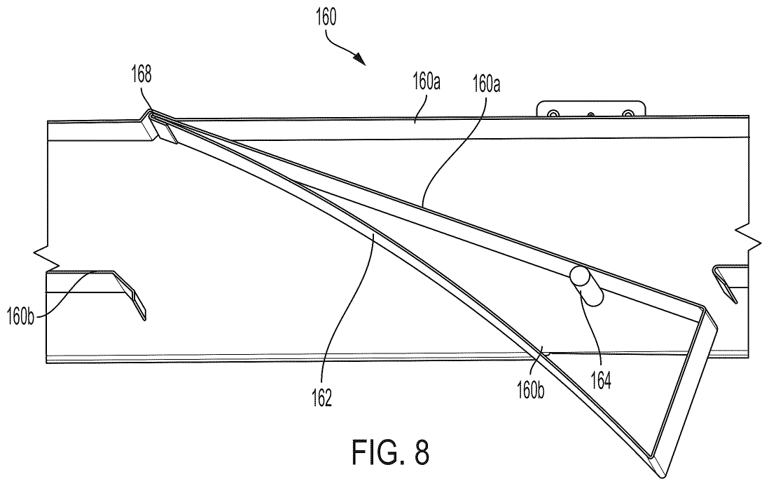

Referring again to FIG. 1, the main duct 130 includes one or more outlets 134 where the packaging articles are released from. Referring to FIGS. 7 and 8, the outlets 134 may include one or more diverters 160. In particular, the outlet 134 is represented by the diverter 160 in an open position (see FIG. 7). The diverter 160 also may function as the main duct 130 when in a closed position (see FIG. 8). The diverter 160 may include a director wall 162 that is configured to open such that, when the director wall 162 is open, the packaging articles are directed through a path defined by the director wall 162 when it passes through the diverter 160.

Referring to FIGS. 7 and 8, the diverter 160 is depicted in a closed configuration and an open configuration, respectively. The director wall 162 of the diverter 160 is positioned on a rotating member 164. The rotating member 164 may be configured to rotate so as to open or close the director wall 162 of the diverter 160. Alternatively, the rotating member 164 could be replaced by a door with hydraulics that opens downwardly. The director wall 162 includes a flat surface 162a that is configured to be flush with the main duct 130 when the diverter 160 is closed. The director wall 162 may include a director surface 162b that extends from a diverter side 160a to a diverter side 160b of the main duct 130 when the diverter 160 is in the open position. Alternatively, the director surface 162b could be fitted with an opening sized to permit dunnage to drop through the opening. While the director surface can be straight or have another suitable shape, in the embodiment shown, the director surface 162b has a curved surface that defines a smooth path for the packaging articles to travel. The diverter side 160a includes a notch 168 which is configured to receive the diverter when the director wall 162 is in an open position. The notch 168 prevents the director wall from being caught in the duct 132. Alternatively, instead of the notch 168, a mechanical latch or catch could be fitted in the diverter side 160a.

The diverter 160 may be configured to be opened or closed manually by a user/operator. Alternatively, the diverter 160 can be controlled by an automated controller. Optionally, the diverter 160 is configured to open when a sensor determines that a receptacle is low on packaging articles (see further discussion below). For example, the packaging articles can be distributed by a controller based on fill levels detected by sensors. The diverter 160 may be configured to close when a sensor determines that a receptacle has enough packaging articles. Alternatively, instead of diverters 160, an opening can be provided without a door.

Referring again to FIG. 1, the main duct 130 includes multiple diverters 160 that act as outlets 134, where the outlets 134 are configured to direct packaging articles to receptacles 122. Each of the receptacles 122 optionally may include an internal divider so as to supply the packaging articles to separate workstations 120, or the receptacles 122 may feed more than one of the workstations 120. For example, the main duct 130 may include the same number of diverters 160 as receptacles 122. Alternatively, the main duct 130 includes a different number of diverters 160 and receptacles 122. In addition, the main duct 130 may terminate with a director 166 at the end of the main duct 130 that is configured to direct packaging articles into the last one of the receptacles 122, and toward the last one of the workstations 120. For example, if there are four workstation 120, the director 166 would be positioned above the last/fourth workstation 120. The director 166 is configured to operate similarly to the directors discussed above. Other configurations are additionally possible such as providing a snake conveyor instead of a receptacle.

In the example depicted at FIG. 1, the conveyance system 100 includes three diverters 160 and the director 166 positioned over two receptacles 122. Each of the receptacles 122 is configured to provide packaging articles to two workstations 120. This configuration is exemplary, but any other configuration may be used. For example, it is possible to include an internal divider to partition each of the receptacles 122 into separate receptacles corresponding to the workstations 120, respectively. In such an arrangement, each of the receptacles 122 would supply a single workstation 120. Alternatively, it is possible for two diverters 160 to be arranged with respect to a single, unpartitioned receptacle 122. The receptacles 122 are depicted as having an opening 122b at the top to receive packaging articles (e.g., pads made of paper dunnage) from the duct 132. For example, the duct can be opened or closed with a cover or any other desired top. This arrangement provides some flexibility, such that one or more of the workstations 120 associated with the receptacle 122 may be used at a given time, e.g., depending on current demand. Optionally, the director 166 may be permanently arranged in an open position. For example, as shown in FIG. 1, the director 166 is configured to direct any remaining packaging articles from the main duct 130 to the last/fourth workstation 120.

The packaging materials are directed into the receptacles 122 at each of the workstations 120. The conveyance system 100 may include the same or a different number of receptacles 122 as outlets 134 or diverters 160. In the example depicted in FIG. 1, each of the receptacles 122 is associated with two workstations 120, each of the workstations 120 being associated with an opening 122a from which packaging materials can be retrieved by operators for packaging and/or shipping operations. The receptacles 122 are adapted to store packaging materials until retrieved by an operator. The receptacles 122 may include one or more sensors that detect when packaging articles are received from the conveyance system 100. In addition, each of the receptacles 122 may include a fill level sensor that detects when the receptacle has reached a full condition indicating that the receptacle is full or running low on packaging articles. For example, when the receptacles 122 are full of packaging articles, the protective packaging machine 110 can be switched off. Optionally, the director 166, outlets 134 or diverters 160 can be opened or closed depending on the amount of packaging articles detected by the sensor and reopened when a predetermined fill level is detected by the sensors.

The conveyance system 100 may include a jam detection feature. For example, sensors of the receptacles 122 may detect each time packaging articles are received by the receptacles 122. After a predetermined amount of time has passed and the receptacle has not received packaging articles, the conveyance system 100 may detect that a jam has occurred in the main duct 130 or elsewhere in the conveyance system 100. Alternatively, different sections of the main duct 130 can be fitted with sensors which detect when packaging passes through the main duct 130, and when packaging articles do not pass through the main duct 130 (e.g., detecting a jam). For example, the sensors can be photocells. Alternatively or additionally, the main duct 130 can include a clear section made from a material such as plexiglass such that an operator can see into the main duct 130 to determine whether the main duct 130 is jammed. The jam detection function can cause the conveyance system 100 to stop producing packaging articles.

The main duct 130 may be formed from a sheet metal material. In particular, the main duct 130 preferably is made from metal such as a malleable metal that is easily formed. For example, the main duct 130 may be formed from a material that is low-density such that it needs little support. The main duct 130 may be formed from an air-tight material or a flexible material. In particular, the main duct 130 may be formed from a material that includes some or all of the properties above. In one non-limiting example, the main duct 130 can be formed from an aluminum or an aluminum alloy material. As another example, as discussed above, portions of the main duct 130 can be formed from a transparent material such that a user can see within the main duct 130. Optionally, a wall of the duct can be formed from a transparent material. For example, the wall can be formed from a material including but not limited to a plexiglass or glass. Alternatively, instead of a metal, the main duct 130 may be formed from various plastics or composite materials.

FIG. 9 is a view of an alternative main duct according to the present disclosure. Referring to FIG. 9, a main duct 330 includes a first wall 330a and a second wall 330b. An elbow 331c provides a bend in the main duct 330 from a first duct section 331a that extends in a first direction to a second duct section 331b that extends in a different, second direction at an angle to the first direction.

The first duct section 331a and the second duct section 331b have similar heights 333a. The elbow 331c widens between the first and second duct sections 331a, 331b to a height 333b which is greater than a height 333a. The wider height 333b prevents dunnage from getting stuck within the elbow 331c as the main duct 330 transitions between the first duct section 331a and the second duct section 331b.

The elbow 331c can be used, for example, in place of the elbow 131c provided in the main duct 130 as shown in FIG. 1. While the elbow 131c provides a bend in the main duct 130 of about 60° (see FIG. 1), the elbow 331c changes the direction of the main duct 330 by approximately 90° from the second duct section 331b (see FIG. 9). The elbow 131c may have the same cross-sectional height as the elbow 331c. The elbows 131c, 331c as shown have straight inner walls. Alternatively, the inner walls of the elbows 131c, 331c may widen, i.e., have wider cross-sectional heights. As a further alternative, instead of an elbow with a greater height than first and second duct sections, it is possible to provide an elbow or bend with a constant cross-sectional, radial height about the bend that corresponds to the height of each of the first and second duct sections 131a, 131b or 331a, 331b.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A packaging material conveyance system for conveying protective packaging articles from a protective packaging machine to a receptacle, the packaging material conveyance system comprising:
a main duct having a packaging article inlet configured to receive formed packaging articles, and having a first outlet configured to allow the packaging articles to exit therefrom, the main duct being elongated and configured to transport the articles in a longitudinal direction within the main duct from the packaging article inlet to the first outlet; and
a blower assembly operably connected to the main duct to generate airflow that enters the main duct from at least two non-adjacent sides of the main duct to propel the articles through the main duct.

2. The conveyance system of claim 1, wherein the packaging article inlet is connected to an outlet of the protective packaging machine that converts a high-density supply material into the packaging articles having a lower density than the supply material.

3. The conveyance system of claim 1, wherein the receptacle is arranged at the first outlet, and configured to receive the articles conveyed by an internal duct airflow from the packaging article inlet to the first outlet.

4. The conveyance system of claim 1, further comprising a blower duct section fluidly connecting the blower assembly and the main duct to introduce the airflow at an angle relative to the longitudinal direction of the main duct.

5. The conveyance system of claim 4, wherein the blower duct section comprises first and second blower duct sections, and the airflow comprises first and second air streams configured to enter the main duct via the first and second blower duct sections at first and second angles, respectively.

6. The conveyance system of claim 5, wherein the first and second angles are not greater than about 90°.

7. The conveyance system of claim 5, wherein the first and second air streams are configured to energize boundary layers on top and bottom sides of the articles, respectively, so as to accelerate the articles from the packaging article inlet of the main duct.

8. The conveyance system of claim 5, wherein the first and second air streams are configured to engage opposite sides of the articles.

9. The conveyance system of claim 5, wherein the blower comprises a first blower for generating the first air stream and a second blower for generating the second air stream.

10. The conveyance system of claim 9, wherein the first blower and the second blower are arranged on the at least two non-adjacent sides of the main duct.

11. The conveyance system of claim 10, wherein the first and second blowers are arranged proximate the packaging article inlet of the main duct.

12. The conveyance system of claim 1, wherein the main duct comprises first and second duct sections, the first and second duct sections each defining a substantially straight path.

13. The conveyance system of claim 12, wherein the first and second duct sections are rectangular in shape.

14. The conveyance system of claim 12, wherein the first duct section is generally horizontal and defines a change in elevation.

15. The conveyance system of claim 12, further comprising an elbow of the main duct arranged between the first and second duct sections, the elbow being wider than the first and second duct sections.

16. The conveyance system of claim 1, wherein the main duct is configured to receive the articles at the packaging article inlet that have been cut and separated by the protective packaging machine.

17. The conveyance system of claim 16, wherein the articles are paper dunnage pads.

18. A packaging material conveyance system for conveying protective packaging articles from a protective packaging machine to a receptacle, the packaging material conveyance system comprising:
a main duct extending a predetermined length from a packaging article inlet to at least a first outlet, the main duct configured to receive the articles output by the protective packaging machine and transport the articles to a first outlet corresponding to the receptacle, the main duct defining a longitudinal direction corresponding to a direction of travel of the articles in the main duct;
a first blower operably connected to a first blower duct section for generating a first airflow that enters the main duct at a first predetermined angle relative to the longitudinal direction; and
a second blower operably connected to a second blower duct section for generating a second airflow that enters the main duct at a second predetermined angle relative to the longitudinal direction,
wherein the first and second air streams are configured to propel the articles through the main duct.

19. A packaging material conveyance system for conveying protective packaging articles from a protective packaging machine to a receptacle, the packaging material conveyance system comprising:
a main duct extending a predetermined length from a packaging article inlet to at least a diverter, the main duct configured to receive the articles output by the protective packaging machine and transport the articles to the diverter corresponding to the receptacle, the main duct defining a longitudinal direction corresponding to a direction of travel of the articles in the main duct;
the diverter being configured to act as an outlet in an open position and as part of the main duct in a closed position, wherein in the open position the packaging articles are diverted into the receptacle and when in the closed position the packaging articles are configured to continue to an additional receptacle that follows the receptacle;
a blower operably connected to the main duct, the blower oriented at an angle to the longitudinal direction of the main duct so as to generate airflow to propel the articles through the main duct; and
the receptacle associated configured to receive the articles conveyed by the internal duct airflow from the inlet to the diverter.

20. The packaging material conveyance system of claim 19, wherein a portion of the diverter is configured to rest within a notch when in the open position.
